(19) United States
(12) Patent Application Publication
(10) Pub. No.: US 2026/0027713 A1
(43) Pub. Date: Jan. 29, 2026

(54) METHODS OF FABRICATING AND MANIPULATING OBJECTS WITHOUT HUMAN INTERACTION

(71) Applicant: APSARA ENERGY LLC, New York, NY (US)

(72) Inventor: Ravi Jeyaratnam, New York, NY (US)

(21) Appl. No.: 19/279,724

(22) Filed: Jul. 24, 2025

Related U.S. Application Data
(60) Provisional application No. 63/675,197, filed on Jul. 24, 2024.

(51) Int. Cl. B25J 9/16

(52) U.S. Cl. CPC B25J 9/1664; B25J 9/1694

(57) ABSTRACT

A system includes a mobile unit with one or more sensors and a mechanical arm, and a stationary unit that includes a first customizable identifier. The one or more sensors are configured to detect a first customizable identifier of the first stationary unit. The one or more sensors collect location data corresponding to the first customizable identifier of the first stationary unit. The mobile unit is configured to align the mechanical arm of the mobile unit with the first stationary unit, based at least in part on the location data corresponding to the first customizable identifier of the first stationary unit.

### TECHNICAL FIELD

This disclosure relates generally to fabrication of and robot manipulation of customizable objects, including but not limited to, methods of enabling robots to autonomously interact with and/or manipulate objects.

### BACKGROUND

Accurate positioning of robots and fine manipulation of objects continues to be a difficult problem with existing technologies and techniques. For example, while many robots can be programmed to move and/or manipulate objects with high precision, such methods tend to be applied to highly specialized cases. In other words, such robots and/or machines are used for specific tasks, and are not generally flexibly adaptable for use in a variety of situations (e.g., with the same level of precision, and without reprogramming or redesign of the robots and/or machines). Improving the existing technologies and techniques to be more flexibly adapted to different scenarios increases the cost-effectiveness of such robots, machines, and other automation, as they can maintain their accuracy and precision in the different scenarios.

In light of these challenges, there is a need for improved methods of enabling robot manipulation of objects.

### SUMMARY

Accordingly, some embodiments described herein include methods to enable robot manipulation of different objects. Such embodiments are suitable for both indoor and outdoor applications, and can be used for a variety of different applications. As referred to herein, a “mobile unit” is often referred to as a “robot,” meaning any unit that is capable of moving itself (e.g., translational movement of the entire unit, within an environment) and/or one or more components (e.g., arms or other manipulators) of the unit.

The techniques described herein refer to specific shapes and manipulations, but are widely applicable across any suitable shape and/or manipulation. This allows for a flexible system that can be adapted for use in different contexts. Some exemplary contexts include movement of or manipulation of dangerous/hazardous materials; accurate positioning of materials for use in and/or with dangerous machinery (e.g., saws, drills, lasers, and/or other hazardous machining equipment); and/or movement of rare materials. Each of these contexts benefits from automation (e.g., via robots), and provides safety and/or business advantages to the reducing the amount of necessary human interaction in these contexts.

Thus, methods are provided for fabricating and/or customizing object to enable easy and accurate manipulation of objects in a variety of contexts.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 shows an exemplary object with a customizable identifier, in accordance with some embodiments.

FIG. 2 shows an exemplary object with a customizable identifier, in accordance with some embodiments.

FIG. 3 shows a method for interacting with an object that includes a customizable identifier, in accordance with some embodiments.

FIG. 4 show a method for interacting with an object that includes a customizable identifier, in accordance with some embodiments.

FIG. 5 shows a method for manipulating an object, via an attached object, in accordance with some embodiments.

FIG. 6 shows a methods for manipulating an object, via an attached object, in accordance with some embodiments.

FIG. 7 shows an example system for using one or more identifiers determining physical motion mapping of one or robots.

FIG. 8 shows a diagram of an example process for outputting one or more identifier CAD models for 3D printing and outputting physical alignment data for an object and one or more identifiers.

FIG. 9 shows a diagram of an example process for using one or more identifiers for motion mapping of a robot.

FIG. 10 depicts a CAD model of an identifier attached to a robot gripper.

FIG. 11 depicts a CAD model of an identifier attached to an object.

FIG. 12 depicts a CAD model of a robot gripper positioned at a chosen position with respect to an object.

FIG. 13 depicts a 3D printed model with a specified identifier to identifier transform.

FIG. 14 depicts using a camera to determine a pose between a first identifier and a second identifier.

FIG. 15 depicts a camera using a side alignment to match a specified transform based on a first identifier and a second identifier.

FIG. 16 depicts using a camera to determine a transform between the camera and an identifier.

Like reference numerals refer to corresponding parts throughout the several views of the drawings.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Many modifications and variations of this disclosure can be made without departing from its spirit and scope, as will be apparent to those skilled in the art. The specific embodiments described herein are offered by way of example only, and the disclosure is to be limited only by the terms of the appended claims, along with the full scope of equivalents to which such claims are entitled.

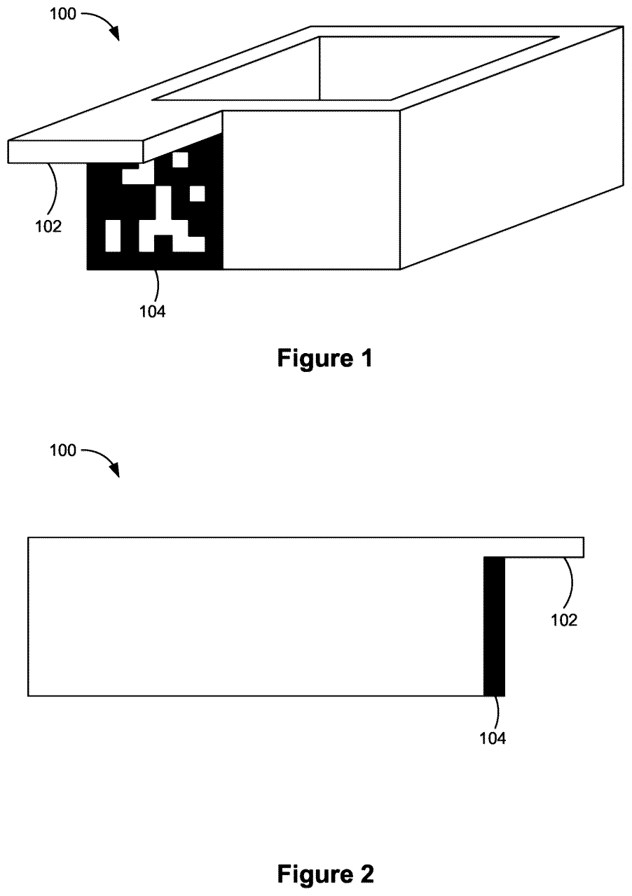

FIG. 1 shows a front-view of an object 100. The object 100 includes a protrusion 102 (e.g., a protrusion configured to allow the object 100 to be grasped, moved, and/or otherwise manipulated) and a customizable identifier 104 (e.g., a QR code or other customizable identifier). In some embodiments, the identifier 104 is positioned on the object 100 with a preset or predetermined relationship to the protrusion 102 (e.g., such that once a robot and/or robot arm is aligned with the identifier 104, the location of the protrusion 102 can be calculated via the known relationship to the identifier 104). In some embodiments, the protrusion 102 is optional (e.g., the object 100 does not include the protrusion 102), or is another physical feature of the object 100 that facilitates manipulation (e.g., grabbing, grasping, moving, turning, and/or rotating) of the object 100 (e.g., the protrusion 102 is and/or is replaced by a handle, a handle bar, a notch/groove, and/or another suitable physical feature).

FIG. 2 shows a side-view of the object 100, and shows that the identifier 104 can be flush with a surface (e.g., a front surface, in FIG. 1) of the object 100. In some embodiments, the shape of the object 100 is irregular or complex (e.g., the front surface of the object 100, as shown in FIG. 1, is not a simple or flat plane). In some embodiments, the identifier 104 does not conform to the surface (e.g., the front surface) of the object 100 (e.g., the identifier 104 is a flat surface embedded in an irregular or complex surface, in order to maintain visibility to sensors and/or cameras). In some embodiments, the surface (e.g., front surface) of the object 100 is a curved surface. In some embodiments, the identifier 104 conforms to the surface (e.g., follows the curve(s) of the surface).

In some embodiments, the identifier 104 is unique to the object 100. In some embodiments, the object 100 is one of multiple objects that are configured for robot manipulation (e.g., the object 100 is a tray or drawer, positioned in a shelf that includes multiple trays or drawers that are analogous to the object 100, each with unique identifiers).

In some embodiments, the object 100 is configured to store one or more items (e.g., the object 100 is a tray or drawer, in which items are stored). In some embodiments, the identifier 104 corresponds to one or more characteristics of the stored items (e.g., a number of items stored in the object 100, or a type or types of items stored in the object 100). This allows for easy identification and organization of different items (e.g., within respective objects that are analogous to the object 100), and allows robots to be programmed to autonomously manipulate objects via respective identifiers, without human intervention (e.g., the robots can be programmed to identify the correct number and/or types of items stored within respective objects, via their respective identifiers). This helps facilitate automation of repetitive tasks (e.g., tasks to performed with respect to all objects storing a particular number and/or type of item), and also reduces the need for human interaction with items stored within the objects (e.g., the items within the objects are hazardous materials which are risky for humans to handle; and/or the items within the objects are valuable materials that may be targets for theft, when handled by humans).

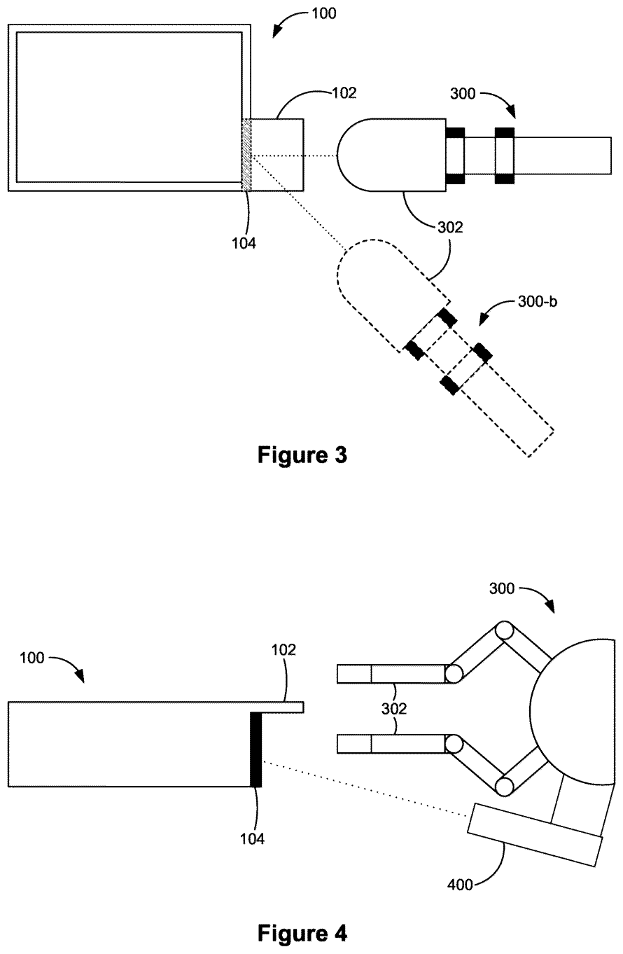

FIG. 3 shows a top-down view of the object 100, along with an exemplary robot arm 300. A robot can align the robot arm 300 with the identifier 104, and the robot arm 300 can be used to manipulate the object 100 (e.g., grippers 302 of the robot arm 300 can be used to grab the protrusion 102 of the object 100). The solid outline of the arm 300 shows a simple case where the robot arm is aligned directly with the identifier 104 (e.g., a length of the robot arm 300 is aligned such that is it orthogonal to a plane defined by the identifier 104). In some embodiments, the robot can align the robot arm 300 with a more complex geometry. For example, as shown by the dotted outline of a robot arm 300-b (e.g., a robot arm that is analogous to the robot arm 300), in some embodiments, the robot can align the robot arm 300-b with a different angle (e.g., such that the robot arm 300-b is not orthogonal to the identifier 104, and optionally, not orthogonal to surfaces of the object 102), as long as the robot has line of sight to the identifier 104. In some embodiments, the identifier 104 is configured (e.g., is shaped and/or positioned) to optimize visibility from desired or expected angles of approach for a robot (e.g., the identifier 104 is angled to be orthogonal to a length of the robot arm 300-b, optionally without changing other physical characteristics of the object 100), to facilitate manipulation by a robot approaching with the robot arm 300-b at the shown angle in FIG. 3.

FIG. 4 shows a side view of the object 100 and the robot arm 300. The robot arm 300 includes a sensor 400 (e.g., a camera, an infrared sensor, a radar, a LiDAR, or other sensor) that is configured to identify and/or locate the identifier 104. In some embodiments, the robot arm 300 includes a plurality of grippers 302 (e.g., two grippers, as shown in FIG. 4), which are configured to manipulate (e.g., grasp) the object 100 via the protrusion 102. In some embodiments, the robot arm 300 is positioned using data from the sensor 400 (e.g., location data and/or distance data, based on the identifier 104) such that the grippers 302 can manipulate the object 102.

In some embodiments, the robot and/or the robot arm 300 includes a plurality of sensors (e.g., sensors analogous to the sensor 400, and/or sensors that are of a different type than the sensor 400). Respective sensors of the plurality of sensors can be positioned at different locations on the robot and/or the robot arm 300 (e.g., such that different sensors have different fields of view), to ensure the robot can identify and locate the identifier 104 (e.g., with only a single sensor, such as the sensor 400, there is a risk that the identifier 104 is not in the field of view of the sensor 400, or the identifier 104 is occluded in the field of view of the sensor 400, due to the geometry of the robot arm 300 itself and/or one or more features of the physical environment). In some embodiments, the sensor 400 (and/or other sensors of the robot) can be repositioned and/or adjusted (e.g., rotated and/or translated along portions of the robot and/or the robot arm 300). For example, the sensor 400 ins FIG. 4 can be rotated from the bottom (e.g., relative to the robot arm 300 as shown in FIG. 4) to the side or top of the robot arm 300, to ensure line of sight to the identifier 104 (e.g., and/or to collect additional data from different points, to increase the accuracy of location and/or distance measurements made via the sensor 400).

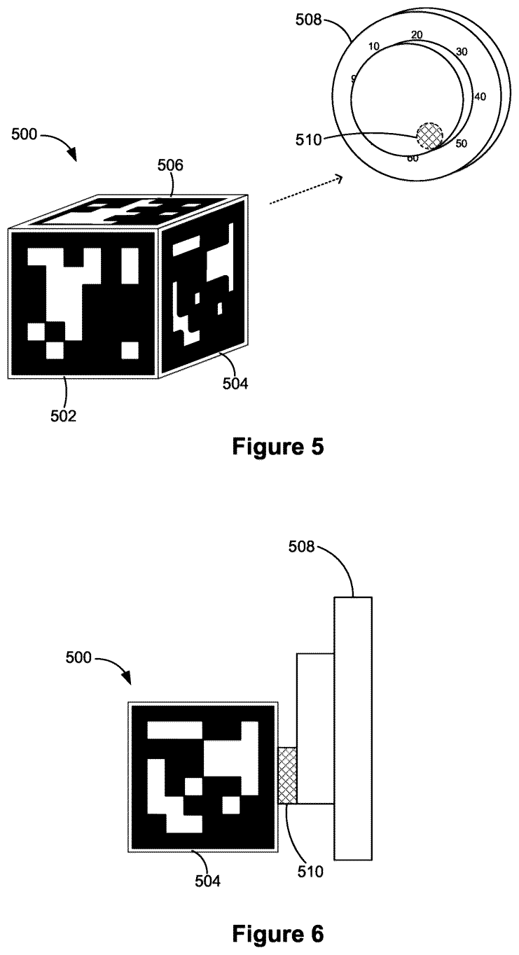

FIGS. 5 and 6 show an object 500 that is configured to enable robot manipulation of other objects (e.g., objects other than the object 500 itself). FIG. 5 shows a dial 508, which can be rotated (e.g., the dial 508 is normally adjusted or manipulated by rotating the entire dial 508 to the desired value), and FIG. 6 shows a side view of the object 500 and the dial 508, where the object 500 is directly attached to the dial 508 via the attachment 510.

Some robot arms, such as the robot arm 300 shown in FIGS. 3 and 4, are not designed to easily manipulate the dial 508 (e.g., the robot arm 300 is not designed specifically for interaction with the dial 508). For example, the dial 508 may lack sufficient surface area, and the robot arm 300 may lack sufficient gripping force, to easily manipulate the dial 508 via the robot arm 300. To better facilitate robot manipulation of the dial 508, the object 500 can be configured to be easily grasped by the robot arm 300 (e.g., the object 500 is a large cube, which proves sufficient surface area to be easily grasped by the robot arm 300). The object 500 is attached to the dial 508 by an attachment 510. While the object 500 would be connected to the dial 508 via the attachment 510 (e.g., as shown by the dotted arrow), for visibility in FIG. 5 (e.g., to show the location of the attachment 510) the object 500 is not directly attached to the dial 508.

In some embodiments, the object 500 is a cube, with a face 502, a face 504, and a face 506. In some embodiments, each face of the object 500 includes a unique identifier (e.g., analogous to the identifier 104 described above), to allow a robot to easily determine a shape (e.g., or at least a number of visible faces) of the object 500, and to position the robot arm 300 accordingly (e.g. to grasp to opposite faces of a cube). In some embodiments, the object 500 is any suitable shape for a robot and/or robot arm 300 to manipulate.

In some embodiments, the attachment 510 is configured to rotate (e.g., such that the dial 508 can be rotated, while the object 500 is attached via the attachment 510, without rotating the object 500 itself). In some embodiments, the attachment 500 is connected to (e.g., attached to) the dial 508 (e.g., and/or the object 500) via an adhesive, magnetic, or other suitable connection.

In some embodiments, the object 500 and/or the attachment 510 is/are fabricated via a 3-D printing process. In some embodiments, the attachment 510 can be customized (e.g., before 3-D printing and/or fabrication) based on a target object to which the attachment 510 will connect the object 500 too. For example, if the attachment 510 will connect the object 500 to a lever or handle, the attachment 510 may include a sleeve and/or a cavity for receiving at least a portion of the lever or handle. If the attachment 510 will connect the object 500 to a button (e.g., a push button), the attachment 510 may not include rotatable components (e.g., to ensure more solid and/or direct transference of motion from the object 500 to the button).

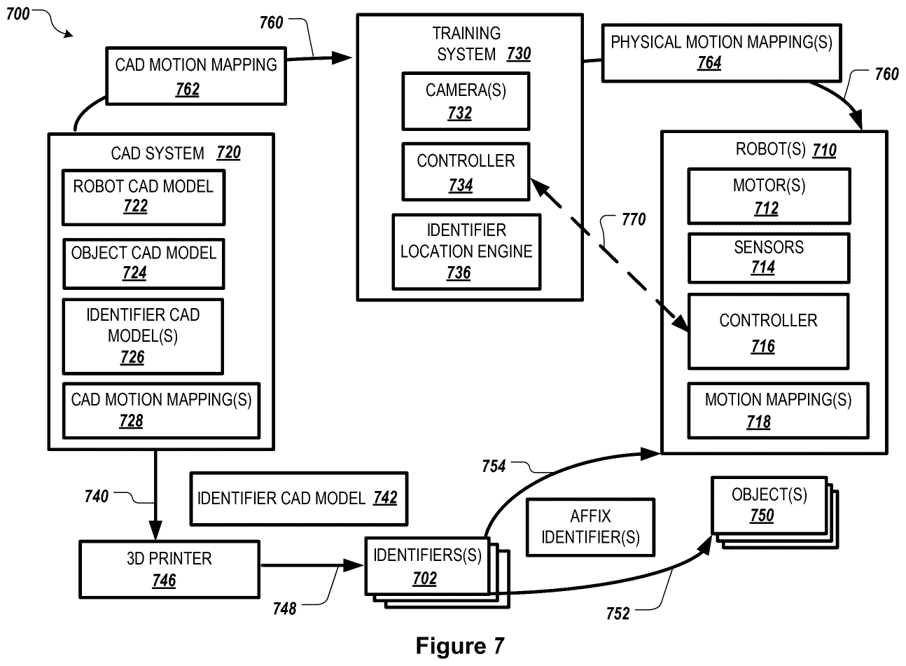

FIG. 7 depicts an example system 700 for using one or more identifiers 710 in determining physical motion mapping of one or robots 710. The one or more identifiers 702 can include a customizable identifier as described and depicted herein. For example, the identifier 710 can include an identifier such as identifier 104 of FIG. 1. The one or more robots 710 can include one or more motors 712, one or more sensors, and/or a controller 716. The controller 716, for example, can be used to control motions and/or movements of the one or more robots 710.

The system 700 can include one or more computer-aided design (CAD) systems such as CAD system 720. The CAD system 720 can include one or more CAD models of one or more robots such as robot CAD model 722. For example, the CAD model 722 can be used to model the movements of a robot. The CAD system 720 can include one or more CAD models of one or more objects such as object CAD model 724. The CAD system 720 can include one or more identifier CAD models 726. For example, an identifier CAD model can be a CAD model of an identifier such as identifier 104 of FIG. 1. The CAD system 720 can include one or more CAD motion mappings 728. For example, a motion mapping can be used to model motion for a modeled robot, identifier, and/or object.

The system 700 can include one or more training systems such as training system 730. The training system 730 can include one or more cameras 732, a controller 734, and an identifier location engine 736. The controller 734 can include a computing system.

As shown at 740, one or more identifier CAD models such as identifier CAD model 742 can be communicated to one or more 3D printers such as 3D printer 746. The 3D printer 746 can include an additive manufacturing machine or other 3D printer. The 3D printer 746 can print a physical identifier using an identifier CAD model such as identifier CAD model 742. As shown at 748, the one or more identifiers 702 are generated by the 3D printer 746.

The one or more identifiers can be affixed to one or more objects 750 and/or one or more robots 710. As shown at 752, at least one of the one or more identifiers 702 are affixed to at least one of the one or more objects 750. For example, an identifier can be affixed to an object located at a selected surface to which the identifier was generated to be attached. As shown at 754, at least one of the one or more identifiers 702 are affixed to at least one of the one or more robots 710. For example, an identifier can be affixed to a robot located at a selected surface to which the identifier was generated to be attached.

As shown at 760, one or more CAD motion mappings such as CAD motion mapping 762 can be sent to training system 730. For example, the CAD system 720 can generate a motion mapping based on the CAD modeling and send that motion mapping to the training system 730. The training system 730 can use the CAD motion mapping 762 to train movement of the one or more robots 710. As shown at 760, the training system 730 can train the one or more robots 710 to move according to one or more physical motion mappings 764. In some implementations, the controller 734 of the training system 730 can send one or more training control signals 770 to the controller 716 of the one or more robots 710. For example, the one or more training control signals 770 can be used to determine control and/or motions of the one or more robots 710. The motions and/or controlled movements of the one or more robots can be included in stored one or more motion mappings 718. The training system 730 can use an identifier affixed to the one or more robots 710 and/or the one or more objects 750 to determine the one or more motion mappings 718. In some implementations, the specific physical alignment of at least one identifier can be used to determine accurate motions of robots with affixed identifiers and/or movements of one or more objects with affixed identifiers.

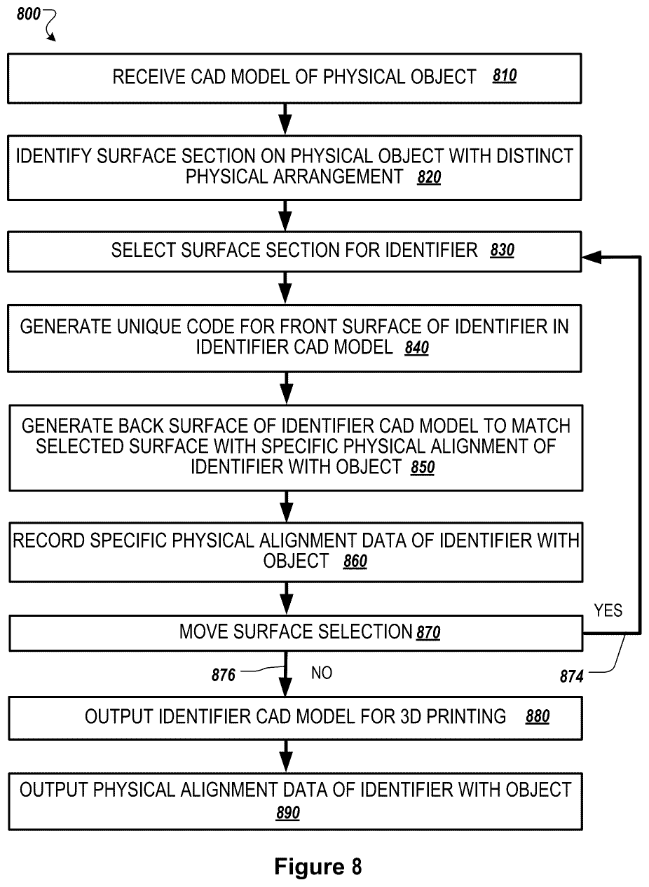

FIG. 8 shows a diagram of an example process 800 for outputting one or more identifier CAD models for 3D printing and outputting physical alignment data for an object and one or more identifiers. At step 810, a CAD model of a physical object is received. For example, a CAD system can receive a CAD model of an object such as object 100 of FIG. 1. At 820, a surface section on the physical object with a distinct physical arrangement is identified. At step 830, the identified surface section is selected for the identifier. For example, the selected surface section can be selected as a location for affixing an identifier. At step 840, a designated code is generated for the front surface of the identifier in the identifier CAD model. For example, the front surface of an identifier can be generated to include a designated code with predetermined dimensions. At step 850, a back surface of the identifier CAD model is generated to match the selected surface with a specific physical alignment of the identifier with the object. For example, the back surface of the identifier modeled can be modeled based on an inverse of the topography and/or shape of the selected surface so that the identifier can be affixed to the selected surface. The identifier can be modeled so that it can be affixed to the selected surface with a specific physical alignment of the identifier with the object. In step 870, it is determined if the selected surface should be moved and/or changed. If it is determined that the selected surface should be moved and/or changed as shown at 874, then the process continues at step 830 and a surface of the object is selected for the identifier. If it is determined that the selected surface should not be moved and/or changed as shown at 876, then the process continues at step 880. At step 880, the identifier CAD model is output for 3D printing. For example, one or more models of identifiers can be output for 3D printing. At step 890, physical alignment data of the identifier with the object is output. For example, the physical alignment data of the identifier with the object can be output for use with motion mapping for a robot and/or other machine.

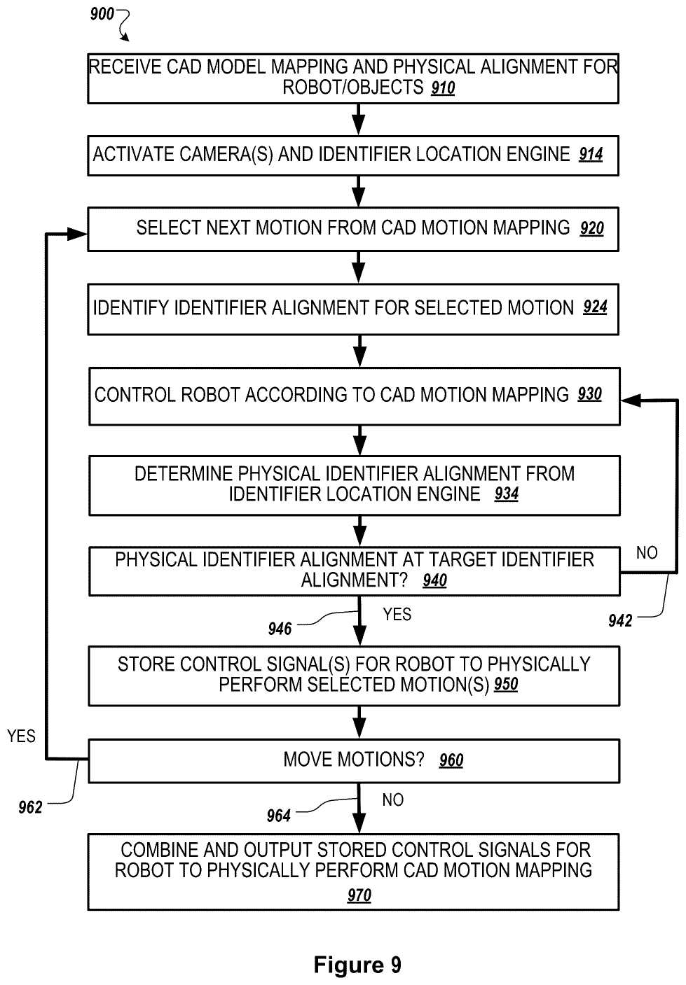

FIG. 9 shows a diagram of an example process 900 for using one or more identifiers for motion mapping of a robot. At 910, a CAD model mapping and physical alignment for one or more robots and/or one or more objects is received. For example, a CAD model mapping and physical alignment can be received at a training system such as training system 730 of FIG. 7. At 914, one or more cameras and an identifier location engine are activated. For example, one or more cameras and an identifier location engine of a training system can be activated. At 920, a next motion is selected from a CAD motion mapping. For example, motion mapping can be included in the received CAD model mapping and a motion can be selected from the received motion mapping. At 924, an identifier alignment is identified for a selected motion. At 930, the robot is controlled according to the CAD motion mapping. For example, the CAD motion mapping information can be used to control movement of the robot according to the CAD motion mapping. At 934, a physical identifier alignment is determined from the identifier location engine. At 940, it is determined if a physical identifier alignment is at a target identifier alignment. For example, a training system can determine if the controlled motion of the robot has achieved a target identifier alignment based on an identifier. If the physical identifier alignment is determined not to be at the target identifier alignment as shown at 942, then the process continues to step 930 and the robot is again controlled according to the CAD motion mapping. If the physical identifier alignment is determined to be at the target identifier alignment as shown at 946, then the process continues to step 950. At step 950, one or more control signals are stored for the robot to physically perform one or more selected motions. At step 960, it is determined if the one or more motions are to be added, moved, and/or changed. If the one or more motions are determined to be added, moved and/or changed as shown at 962, the process continues to step 920, and a next motion is selected from the CAD motion mapping. If the one or more motions are determined not to be added, moved, and/or changed as shown at 964, the process continues to step 970. At step 970, the one or more stored control signals for the robot are combined and output to physically perform the CAD motion mapping. For example, the one or more control signals can be output for use by a robot to perform physical motion according to the CAD motion mapping.

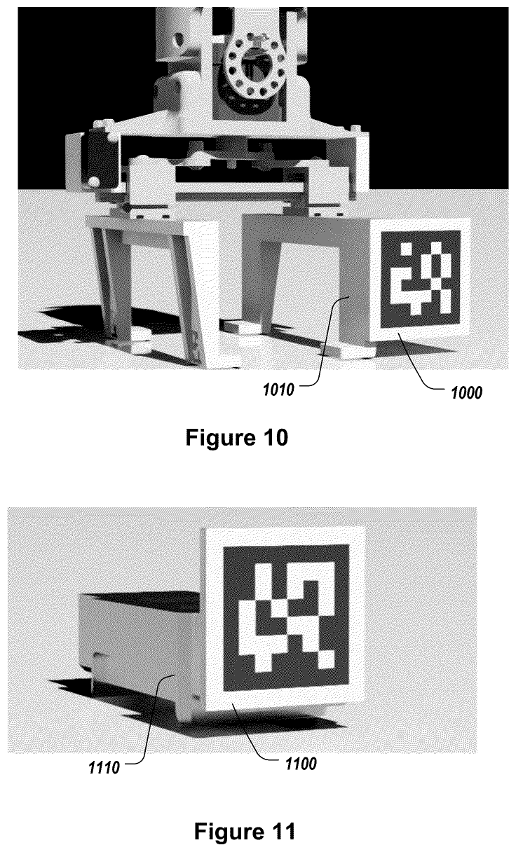

FIG. 10 depicts a CAD model of an identifier 1000 attached to a robot gripper 1010.

FIG. 11 depicts a CAD model of an identifier 1100 attached to an object 1110.

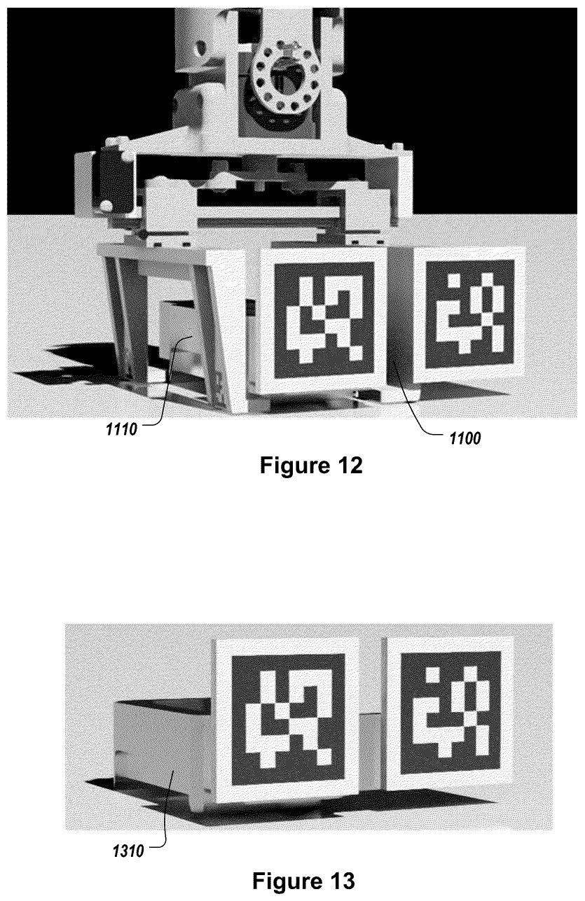

FIG. 12 depicts a CAD model of a robot gripper 1010 positioned at a chosen position with respect to an object 1110.

FIG. 13 depicts a 3D printed model 1310 with a specified identifier to identifier transform.

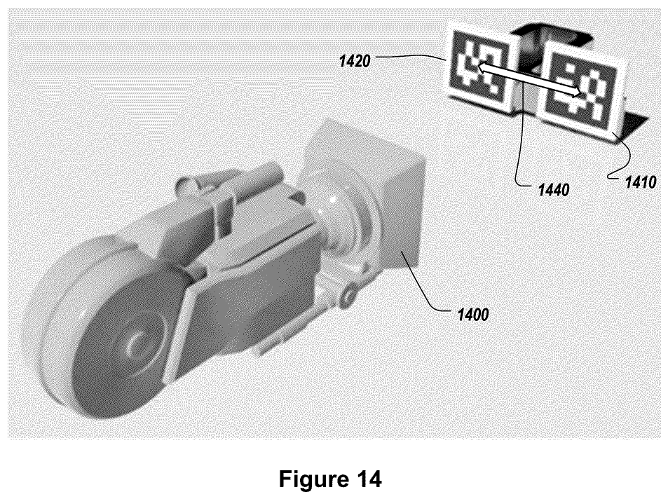

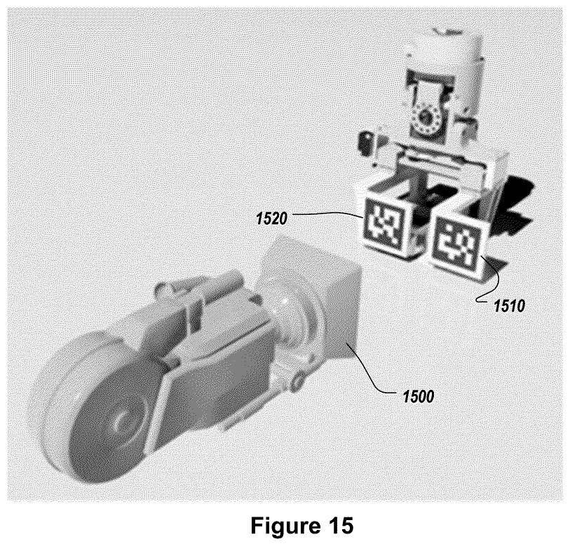

FIG. 14 depicts using a camera 1400 to determine a pose 1440 between a first identifier 1410 and a second identifier 1420.

FIG. 15 depicts a camera 1500 using a side alignment to match a specified transform based on a first identifier 1510 and a second identifier 1520.

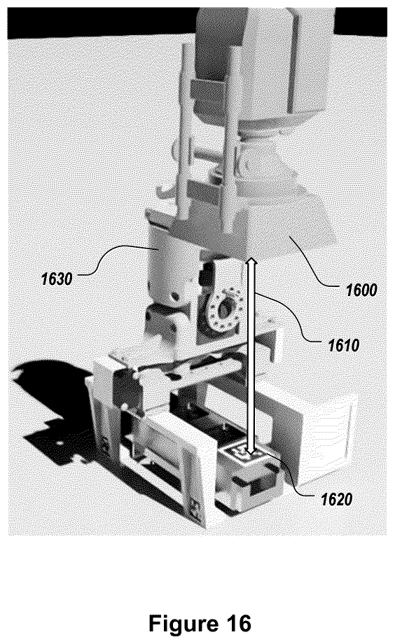

FIG. 16 depicts using a camera 1600 to determine a transform 1610 between the camera 1600 and an identifier 1620. The determined transform 1610 can be used for one or more subsequent alignments for the robot 1630.

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

It will also be understood that, although the terms first, second, etc. are, m some instances, used herein to describe various elements, these elements should not be limited by these terms. These terms are only used to distinguish one element from another. For example, a first current could be termed a second current, and, similarly, a second current could be termed a first current, without departing from the scope of the various described embodiments. The first pose and the second pose are both poses, but they are not the same pose unless explicitly stated as such.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

1. A system, including:
a robot that includes:
one or more sensors;
a mechanical arm;
a first object that includes a first customizable identifier;
wherein:
the one or more sensors are configured to detect a first customizable identifier of the first object;
the one or more sensors collect location data corresponding to the first customizable identifier of the first object;
the robot is configured to align the mechanical arm of the robot with the first object, based at least in part on the location data corresponding to the first customizable identifier of the first object.

2. The system of claim 1, wherein the customizable identifier is 3D printed as a single, integral unit, with the first object.

3. (canceled)

4. The system of claim 1, wherein:
the customizable identifier has a first color; and
the first portion of the surface of the first object has a second color that is different from the first color.

5. The system of claim 1, wherein the customizable identifier has a predetermined shape.

6. The system of claim 1, wherein:
the customizable identifier has at least one flat surface;
the customizable identifier is located on the first surface of the first object; the first surface is an irregular surface.

7. The system of claim 1, wherein:
the customizable identifier is located on a mechanical mechanism of the first object, wherein at least a portion of the mechanical mechanism is configured to be manipulated or moved independently of other portions of the first object.

8. The system of claim 1, wherein the customizable identifier is a barcode.

9. The system of claim 1, wherein the customizable identifier is a QR code.

10. The system of claim 1, wherein the first object includes a container.

11. The system of claim 1, wherein the first object is configured to be manipulated or moved by the mechanical arm of the robot.

12. The system of claim 1, including a second object that is different from the first object; and
wherein:
the second object includes a second customizable identifier;
the second object has a different shape than the first object; the one or more sensors are configured to detect the second customizable identifier of the second object;
the one or more sensors collect location data corresponding to the second customizable identifier of the second object;
the robot is configured to align the mechanical arm of the robot with the second object, based at least in part on the location data corresponding to the second customizable identifier of the second object.

13. The system of claim 1, wherein the customizable identifier includes at least one surface that is conformal with at least a first portion of a surface of the first object.

14. The system of claim 2, wherein the customizable identifier includes at least one surface that is conformal with at least a first portion of a surface of the first object.

15. A method for using one or more identifiers for motion mapping of a robot, the method comprising:
receiving a CAD model mapping and a physical alignment for one or more robots;
activating one or more cameras and an identifier location engine;
selecting a next motion from a CAD motion mapping;
identifying an identifier alignment for a selected motion;
controlling the robot according to the CAD motion mapping;
determining a physical identifier alignment from the identifier location engine;
determining if a physical identifier alignment is at a target identifier alignment;
storing one or more control signals for the robot to physically perform one or more selected motions;
combining the one or more stored control signals for the robot; and
outputting the combined one or more stored control signals for the robot to physically perform the CAD motion mapping.

16. The method of claim 15 further comprising receiving a CAD model mapping and a physical alignment for one or more objects.

17. The method of claim 15 further comprising determining if the one or more selected motions are to be moved.

18. The method of claim 15 further comprising:
based on a determination that the physical identifier alignment is not at the target identifier alignment, again controlling the robot according to the CAD motion mapping.

19. The method of claim 15 further comprising:
if it is determined that the one or more motions are be moved, a subsequent next motion is selected from the CAD motion mapping.

20. The method of claim 15, wherein the controlling the robot according to the CAD motion mapping comprises using CAD motion mapping information to control movement of the robot according to the CAD motion mapping.
